(19) United States
(12) Patent Application Publication
(10) Pub. No.: US 2015/0088611 A1
(43) Pub. Date: Mar. 26, 2015

(54) Methods, Systems and Apparatus for Estimating the Number and Profile of Persons in a Defined Area Over Time

(71) Applicants: Hendrik Wagenseil, Nuremberg (DE); Markus Ziegler, Nuremberg (DE); Volker Bosch, Feucht (DE)

(72) Inventors: Hendrik Wagenseil, Nuremberg (DE); Markus Ziegler, Nuremberg (DE); Volker Bosch, Feucht (DE)

(21) Appl. No.: 14/035,010

(22) Filed: Sep. 24, 2013

(51) Int. Cl. G06Q 30/02; H04W 64/00

(52) U.S. Cl. CPC G06Q 30/0205; H04W 64/00
USPC 705/7.34

(57) ABSTRACT

A passive measuring technique and system processes and analyzes imprecisely reported location estimates collected from a plurality of mobile devices. The number and socio-demographic composition of persons within defined areas of interest are estimated over time. Each mobile device is assigned to a group and identified by an anonymized identifier, and the identifiers of devices within each group are refreshed on a rolling basis to further enhance privacy. A statistical weighting approach is applied so that each device represents a fraction of the population and socio-demographic profile of one or more segmentation districts. Users requesting a defined area of interest via a communication network receive an estimate—derived by modeling respectively anonymized mobile devices within an area of interest over a selectable time period as corresponding, statistically weighted devices—of the number and socio-demographic profile of all persons within the area of interest over the selectable time period.

### BACKGROUND OF THE INVENTION

1. Field of the Invention

This disclosure relates generally to market research, and, more particularly, to methods and systems for using collected mobile device location data to estimate the number and characteristics of persons within a defined area over a defined period of time.

2. Discussion of the Background Art

Retailers are always looking for ways to verify that their marketing messages are reaching the intended audience (i.e., “exposure”) and, wherever possible, to measure what effect those messages are having on consumer behavior (i.e., “effectiveness”). With regard to measuring exposure to messages delivered by media channels such as television, radio, and print, a common approach is to recruit and monitor the behavior of a group of respondents that are collectively representative of a population of interest. Exposure to advertising messages delivered via television or radio is most often measured passively, via devices which are worn, carried or located in the vicinity of the respondents. Passive measurement techniques are especially preferred by market research companies because it is easier to retain respondents once they have been recruited, the collection of data is easier and more efficient, and the impact of “human error” upon the measurements themselves is largely avoided.

An alternative, “active” approach to ad exposure measurement is to interview respondents on a recurring basis. The active approach is relied upon when measuring readership and exposure to advertisements delivered via print media. As well, the active approach is equally efficacious when it comes to measuring print ad effectiveness. The effectiveness of ads placed in specific issues of a publication, for example, can be measured by asking readers of those issues whether they noted a particular ad and to identify what, if any, action they took after seeing the ad. Such an approach can provide a very effective means for assessing the overall reach and effectiveness of a manufacturer's nationwide advertising campaign. However, no insights are presently offered to the manager of a retail store or operator of a chain of stores who may be seeking a more granular approach to measuring effectiveness. By way of illustration, such managers and operators have lacked any convenient and efficient means for measuring variations in the number and characteristics of people within their stores—as would be indicative of the positive, negative or neutral response on the part of targeted consumers—to a local advertising campaign.

Moreover, when it comes to measuring effectiveness of a retailer's advertising campaign over across multiple channels of media, the active approach of surveying respondents is simply impractical. It would be unreasonable to expect that the costs associated with recruiting (and maintaining) such a panel—and with collecting, from each respondent, all of the information that would be required—could ever be recovered in the marketplace.

Outside of the effectiveness measurement context, there are many other situations where retailers, commercial property developers, and others could make use of a tool which enables them to select one or more areas of interest and thereafter monitor variations in the overall number and socio-demographic profile of the people disposed within those areas over a defined time interval (day of week, hour of day, time of year, etc). By way of illustrative example, access to such information would aid in the timing of promotional events, in the selecting of sites for commercial development, and even in deciding where to situate a business or open a new store.

With more and more people carrying around and using mobile devices as they travel to various places in their daily activities, the smart phone or tablet would seem to be the ideal means by which such information could be collected—and for a large enough volume of people for the collected information to be statistically significant. Mobile devices are continually increasing in their capabilities and processing power, allowing them to be utilized in ways other than traditional voice communication. For example, many mobile devices are now equipped with a global positioning system (GPS) receiver or other similar component for determining their location.

Unfortunately, current GPS receivers are not energy-efficient, consuming a significant amount of power—from mobile device batteries that have limited capacity to begin with. For example, a smart phone with a GPS receiver engaged typically consumes 250+ microamperes per hour, which could limit the usage of a typical smart phone battery to less than four hours if used continuously. Depending upon the frequency of location estimates being supplied by a user's device, the battery drain penalty could conceivably rise to a level that is, at best, noticeable and, at worst, unacceptable to the user.

The increased rate of power consumption is not the only reason a user might object to—or even outright reject—the notion of having his or her GPS-equipped mobile device configured to continuously supply location estimates—even for such innocuous applications as market research. Many, if not most, mobile device users have a visceral dislike for the idea of having their movements tracked, even if it is on an anonymous basis. Indeed, given the precision afforded by GPS, there is a valid concern that an individual's residence and other important places of living (IPL) such as his or her school or workplace, and thus, the very identity of the user, might be ascertained merely by collecting and analyzing anonymous position estimates over a long enough period of time.

A continuing need therefore exists for a method and system for collecting and utilizing mobile device location estimates in a manner which precludes the derivation of a device owner's identity—even after monitoring such estimates over a prolonged period of time.

A further need exists for a passive measuring technique and system operative to process and analyze the collected, imprecise location data so as to discern variations, over time, in the number and socio-demographic composition of persons within a defined area of interest.

A further need exists for a system capable of accepting, over a communication network, a user's request defining one or more areas of interest and, responsive to such request, returning data to the user representative of the number and/or socio-demographic profile of the people within that area over one or more defined time intervals.

### SUMMARY OF THE INVENTION

The aforementioned needs are addressed, and an advance is made in the art, by a passive measuring technique and system which processes and analyzes location data that has been collected from a plurality of mobile devices. The system estimates variations, over time, in the number and socio-demographic composition of persons within a defined area of interest.

In accordance with an illustrative embodiment of the disclosure, each mobile device is assigned, by a processor, to one of a plurality of group of mobile devices and each of these devices is identified by an anonymized identifier so that a recipient of the collected location estimates is unable to identify the owner of any particular device. To further enhance privacy, however, the processor executes instructions stored in memory so that the anonymized identifiers assigned to each device in a group are refreshed on a staggered, rolling basis.

In accordance with an illustrative embodiment of the disclosure, a statistical weighting approach may be applied so that each device represents a fraction of the population within one or more of the segmentation districts to which the device—on the basis of location estimates collected when the device owner is most likely to be at home (e.g., during night time hours)—is assigned. In accordance with this exemplary embodiment of the disclosure, if a device represents more than one segmentation district, the statistical weight of the device takes into account the population of each of the one or more segmentation district it represents as well as the socio-demographic characteristics of this population.

According to an aspect of an exemplary embodiment of the disclosure, users specifying one or more defined areas of interest via, for example, a web portal or other communication network, can request an estimate of the number and socio-demographic profile of all persons within the area of interest over the selectable time period. These estimates may be derived by modeling any anonymized mobile device, mapped to the area within the applicable time period(s), as one of the aforementioned statistically weighted devices. By summing the respective weights of each device, variations in both the absolute number and in the socio-demographic profile of the people within a defined area can be estimated and reported to the user.

According to another aspect of an exemplary embodiment of the disclosure, a defined area of interest can be specified using a graphical depiction of a map, in which the user may define a polygon shape which encompasses the areas from which measurements are to be taken and for which estimates are to be provided. As additional location estimates are collected from the area, the analysis is refreshed so that updated measurements will be available for graphical presentation to the user at the time of his or her next access to an analysis and reporting platform constructed in accordance with the teachings of an illustrative embodiment of the disclosure.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a mobile subscriber network suitable for collecting and providing anonymized location estimates, for each of a plurality of groups of anonymized mobile devices, in accordance with an exemplary embodiment of the disclosure;

FIG. 2 is a flow chart representing exemplary machine readable instructions that may be executed, in accordance with the exemplary embodiment of the invention depicted in FIG. 1, to employ a rolling, device identifier re-assignment scheme in order to enhance the privacy of the mobile subscribers;

FIG. 3 is a tabular representation depicting an exemplary application of a rolling identifier re-assignment scheme according to the exemplary process depicted in FIG. 2, to an arrangement in which the mobile devices to be anonymously identified are allocated among four groups;

FIG. 4 is a tabular representation depicting the location estimates collected, between identifier refresh cycles, for each mobile device of an exemplary group of devices, within a time window corresponding to a time of day when the device owner is likely to be at an important place of living (e.g., home, office, or school);

FIG. 5 is a block schematic representation of a defined area analyzer and estimate reporting system configured in accordance with an illustrative embodiment of the disclosure;

FIGS. 6A-6C depict the superposition of geographic subunits (e.g. a two-dimensional array of grid cells applying an orthogonal mapping system such as latitude and longitude) onto segmentation districts, with only those geographic subunits encompassed by the zone defined by a corresponding location estimate associated with a representative device being shown and with each geographic subunit being situated within exactly one segmentation district;

FIG. 7A depicts the accumulation of data from multiple location estimates for the representative mobile device associated with FIGS. 6A-6C, with those geographic subunits having the highest frequency of being encompassed by the location estimates being associated with an inner “core home zone” for the device;

FIG. 7B depicts the core home zone obtained when filtering criteria are applied to remove certain geographic subunits from further home zone analysis for a given device;

FIG. 8A is a tabular representation, for representative mobile devices A₁ through An (for which location estimates have been collected), that associates an unweighted value to the probability that the residence of each mobile device's owner is located within a given segmentation district;

FIG. 8B is a tabular representation depicting the assignment of a first weighting factor to the representative districts depicted in FIG. 8A;

FIG. 8C is a tabular representation depicting the application of a time varying tWeight value which is used to account for time varying fluctuations in the number of active devices over the course of a fourteen hour day;

FIG. 9 is a flow chart representing exemplary machine readable instructions that may be executed, in accordance with the exemplary embodiment of the invention depicted in FIG. 5, to process and analyze anonymized location estimates and provide estimates of the number of socio-demographic profiles of persons with one or more defined areas of interest over a selectable time frame;

FIG. 10 is a flow chart representing exemplary machine readable instructions that may be executed, in accordance with the exemplary embodiment of the invention depicted in FIG. 5, and the illustrative process depicted in FIG. 9, to assign each anonymized device to one or more segmentation districts;

FIG. 11 is a flow chart representing exemplary machine readable instructions that may be executed, in accordance with the exemplary embodiment of the invention depicted in FIG. 5 and the illustrative process depicted in FIGS. 9 and 10, to assign statistical population and profile weighting to each anonymized device in accordance with the segmentation district(s) to which each device is assigned, and to generate, render and graphically depict estimates of the number and socio-demographic profile of persons within a defined area of interest over a selectable time frame; and

FIG. 12 is a schematic illustration of an example processor platform that may execute the instructions of FIG. 2 and/or FIGS. 9-11 to implement any or all of the exemplary methods, systems and apparatus described herein.

Like reference numerals indicate like elements in the drawings. Unless otherwise indicated, elements are not drawn to scale.

### DETAILED DESCRIPTION

The present disclosure provides systems and methods for obtaining mobile device location estimates in an energy efficient manner, and for making these estimates available to market research companies in an anonymized format so as to safeguard the identities of the respective mobile device owners. The present disclosure also provides systems and methods for processing and analyzing such estimates so that they can be used report estimated variations in the number and profile of persons in one or more user-defined areas over time.

In one or more embodiments the location estimates are analyzed so as to predict a correspondence between one or more important places of living and the corresponding mobile device. Each device so analyzed is modeled as a statistically weighted representation of a group of people from the one or more segmentation districts (e.g., census tracts) corresponding to one of the important places of living associated with that device. As will soon be discussed in greater detail, the number and socio-demographic profile of the group of people represented by each such “statistical device” will depend, among other things, on the population of each applicable segmentation district, the relative distribution of “sightings” of a device—during the time period that a typical device owner would be expected to be home—amongst multiple segmentation districts, and the total number of devices sighted in each segmentation district during that same time period.

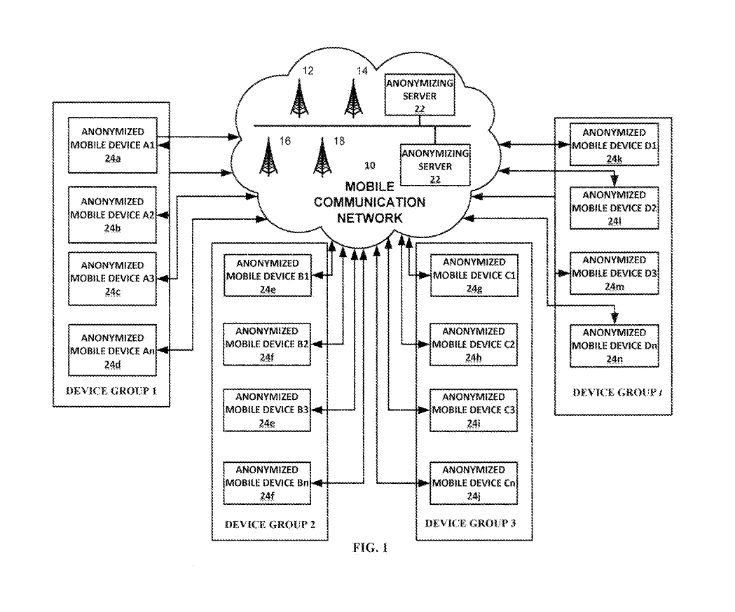

Referring now to FIG. 1, a block diagram of a networked system 10 that may be configured to provide anonymized location estimates is depicted in accordance with an illustrative embodiment of the disclosure. Networked system 10 includes a plurality of towers, indicated generally at 12, 14, 16 and 18, capable of exchanging communication signals with respective mobile devices as devices A1-An of device group 1, devices B1-Bn of device group 2, devices C1-Cn of device group 3, and devices D1-Dn of device group t (where t is an integer representing the total number of device groups). Networked system further includes a location tracking server indicated generally at 20 and a device anonymizing server indicated generally at reference numeral 22.

For ease of illustration and clarity of description, only four mobile devices are depicted in each of device groups 1-t, as devices 24a-24d corresponding to devices A1-A3 and An of device group 1, devices 24e-24h corresponding to devices B1-B3 and Bn of device group 2, devices 24i-24l corresponding to devices C1-C3 and Cn of device group 3 and 24m-24p corresponding to devices D1-D3 and Dn of device group t. The mobile devices, collectively and generally referred to herein by the reference numeral 24, are randomly assigned to each device group and each device group contains—at least initially—substantially the same number of mobile devices. Respective users (not shown) are respectively associated with corresponding mobile devices as devices 24a-24p, the mobile devices 24 being carried by the users during travel to various places in their daily activities. Location estimate server 20, device anonymizing server 22, and mobile devices 24 may each include one or more processors, memories, storages, and other appropriate components for implementing various applications (“apps”), services, data structures, and other software and/or hardware modules described below.

It should be emphasized that the various components of networked system 10 are show in FIG. 1 for purposes of illustration only, and that the various components may be combined, replicated, omitted or otherwise modified as an appropriate for particular implementations of networked system 10. For example, although four mobile devices 24 are shown in each device group of FIG. 1, and only four device groups are depicted therein (i.e., t=4), networked system 10 may comprise any number of mobile devices 24 as desired or applicable. To make the largest volume of location estimate data available for market research and analysis purposes, all non-excluded devices 24 having subscription access to the communication functions of networked system 10 (e.g., sms text messaging services, internet access, and voice services) would be randomly assigned to one of the device groups 1-t. Examples of devices which might be excluded from the assignment and tracking services provided in accordance with the teachings of the present disclosure include those owned by certain governmental entities and those owned by users who have “opted out” of having their mobile device movements tracked (or who have not “opted in” to such tracking, as the case may be).

As shown, networked system 10 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It may be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Networked system 10, in one embodiment, may be implemented as a single network or a combination of multiple networks. For example, in various embodiments, networked system 10 may include the Internet, one or more intranets, landline networks, wireless networks (e.g., through Wi-Fi, Bluetooth, near-field communication (NFC), or other wireless communication technology), and/or other appropriate types of communication networks. In another example, network 10 may include a wireless telecommunications network (e.g., 3G, 4G, HDSPA, LTE, WiMax, or other cellular phone network) adapted to communicate with other communication networks, such as the Internet.

Each mobile device 24 may be implemented using any appropriate combination of hardware and/or software configured for wireless communication over networked system 10. In various embodiments, mobile device 24 may be implemented as a mobile telephone (e.g., smartphone), tablet computing device, personal digital assistant (FDA), notebook computer, and/or various other generally known types of wireless mobile computing devices. For example, mobile device 24a may be a smartphone such as an iPhone™, mobile device 24b may be a tablet device such as an iPad™, and mobile device 24c may be a laptop computer, or other mobile device. The respective mobile devices 24 may be running the iOS™ operating system, the Android™ operating system, a BlackBerry™ operating system, the Microsoft® Windows® operating system, Symbian™ OS, webOS™, or other suitable operating system.

In various embodiments, each mobile device 24 may include software and/or hardware components, modules, routines, services, and/or applications that may be configured to track the location of mobile device 24 and report the same, at regular or requested intervals, to location estimate server 20 of networked system 10. For example, in various embodiments, mobile device 24 may include a location service (not shown) that may run on mobile device 102A as a background process or service to determine and record the location of mobile device 24 at defined times of day. By way of illustration, such a location service may interface with a geo-positioning receiver (not shown) to determine the geo-position of mobile device 24. In various embodiments, such a location service may be configured to control (e.g., turn on or off, adjust the sampling rate, or adjust other operational parameters) of the geo-positioning receiver to minimize power consumption.

A geo-positioning receiver of each device may be implemented with a global positioning system (GPS) receiver configured to communicate with a network of orbiting satellites to determine a geo-position using trilateration and/or other suitable techniques. Alternatively, each geo-positioning receiver may be implemented with appropriate hardware and/or software configured to determine a geo-position using various other techniques, such as a GSM localization or other similar technique based on multilateration of signals from multiple cell sites, a control plane locating or other similar technique based on radio signal delays of cell sites, or a local-range positioning technique based on WiFi or other local-area connections. It is also contemplated that a geo-positioning receiver may be implemented using any combination of the techniques described above. Various implementations of geopositioning receivers described above may permit determination of a geo-position with high accuracy, but typically at the cost of high battery usage. For this reason, device location estimates collected through use of a mobile device's GPS receiver would be limited to intermittent use (e.g., activation of a GPS location and reporting service on a mobile device at defined intervals). For the market research purposes contemplated by the present disclosure, such intermittent and infrequent availability of estimates would likely be inadequate. However, for devices additionally equipped with an accelerometer, the approach described in Published U.S. Patent Application 2013/0085861, entitled PERSISTENT LOCATION TRACKING ON MOBILE DEVICES AND LOCATION PROFILING and filed by Dunlap on Apr. 4, 2013 (the disclosure of which is expressly incorporated herein in its entirety), may optionally be utilized to collect and furnish location estimates to networked system 10 on a much more frequent basis.

In other embodiments, position estimating functionality is carried out by networked system 10 using conventional triangulation techniques. By way of illustrative example, each time a mobile device as device 24a interacts with networked system 10, signals are received by multiple antennas as antennas 14, 16 and 18. Utilizing triangulation and, optionally, received signal power measurements at each antenna, a very precise set of longitude and latitude (x, y) coordinates can be estimated for each device 24. Such an implementation has the benefits of avoiding any increase whatsoever in the power consumption of mobile devices and avoiding the necessity of recruiting device users to download and activate an application program as contemplated by Dunlap.

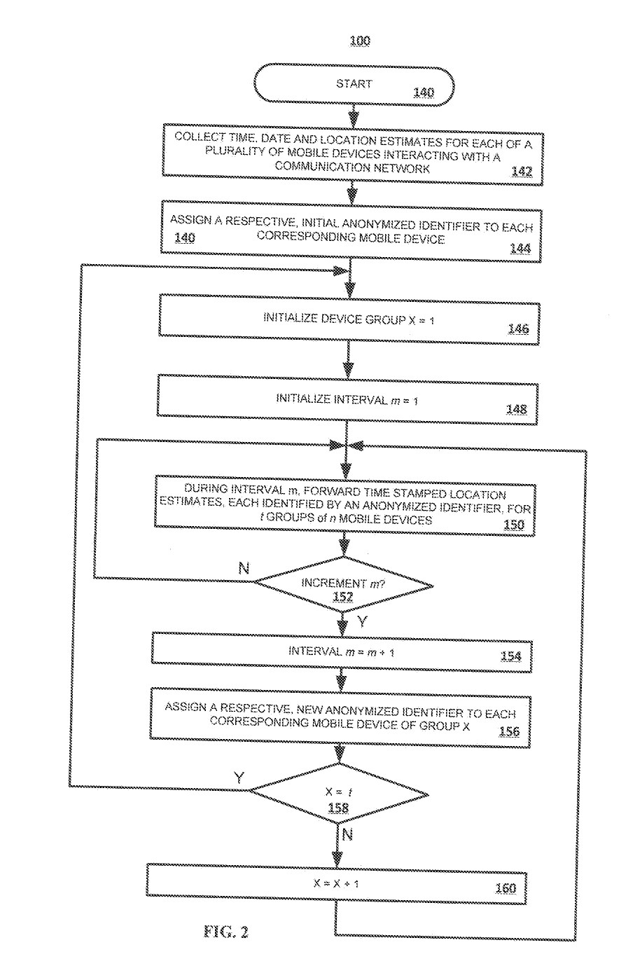

Regardless of the manner in which the location estimates are collected, these are collected or aggregated centrally as by location estimate server 20 and, in a manner which will now be described, the identity of the device 24 to which each collected location estimate applies is associated with an anonymized identifier that is periodically changed to safeguard the privacy of each user. With particular reference now to FIG. 2, there is depicted a flow chart representing exemplary machine readable instructions that may be executed, in accordance with the exemplary embodiment of the invention depicted in FIG. 1, to employ a rolling, device identifier re-assignment process 100 in order to enhance the privacy of the mobile subscribers.

Process 100 is entered at start block 140 when, for example, respective devices 24 interact with networked system 10 and, at block 142, a time, date and location estimate is collected upon each such interaction. As mentioned previously, the advantages of synchronizing the collection of estimates to interactions between networked system 10 and each mobile device 24 is this approach requires no additional energy expenditure on the part of the mobile devices themselves. It should, however, be readily appreciated that if the location estimates are to be periodically received from mobile devices 24, then the aforementioned synchronization is not necessary and may be omitted.

Returning momentarily to FIG. 1, device anonymization server 22 assigns a unique identifier to each device 24 for which an estimate is collected. In operation, anonymization server 22 receives one or more non-anonymized but identifiers from location estimate server 20. Identifiers received from the location estimate server may be implemented by, for example, an IMEI number, a telephone number, a user identifier, and/or any other identifier that will remain constant throughout use of the mobile device 24.

To maintain privacy for the user of mobile device 24, anonymization server 22 applies a one-way hash to the received identifier. This assignment of anonymized identifiers to the mobile devices 24 is depicted in block 144 of FIG. 2. Thus anonymized, each location estimate is stored by location estimate server 20 for subsequent retrieval, processing and analysis. Each location estimate includes a set of x and y coordinates as, for example, the longitude and latitude of each device “sighting” reported by GPS or antenna triangulation, and to this is appended a linear radius measurement r. Collectively, the aforementioned variables define a circular “zone of certainty” or “zone of confidence” within which a device 24 was disposed at a particular point in time (e.g., at the time of a corresponding, specific network interaction). By way of illustrative example, the x-coordinate lies along a line of longitude, while the y-coordinate lies along a line of latitude. The value of radius r is reported such that with a high level of confidence (say, on the order of 95%), the applicable device is within r around (x, y). The interaction which prompts collection of a location estimate for a device may include, but is not limited to, the instantiation of a voice call, an SMS message, a UMTS exchange, or an idle device management process invoked between a device and the mobile communication network 10.

It should be emphasized that the zone of certainty exemplified above may be defined using other shapes and measurements. It suffices to say that by sufficiently expanding the zone of certainty, the ability of a third party to associate a particular device with a particular residential address, work place or other important places of living may be rendered very difficult or even impossible. However, rather than rely entirely on the size of a location estimate's zone of certainty—which might otherwise induce a network operator to provide estimates which cover too large an area to yield useful results—it is proposed herein to utilize a rolling identifier assignment scheme for updating the anonymized device identifiers by group, which will now be described.

There are t device groups of devices, with the devices of each group to be refreshed in batches at an assigned interval which, by way of an illustrative example where t equals four groups of devices, each respective group of devices may be assigned to a corresponding week so that by the end of a four-week cycle, all groups of devices will have been updated with replacement identifiers. Accordingly, and with continued reference to FIG. 2, it will be seen that the device group counter is initialized at block 146 and the identifier refresh interval counter is initialized at block 148. At block 150, anonymized location estimates collected during interval m for each of the t groups of subscribers are forwarded by, or retrieved from, location server 20 for processing and analysis according to other aspects of the present disclosure.

At decision block 152, the process of forwarding (or making available) collected location estimates using previously assigned anonymized identifiers will continue to return to block 150 for as long as there is still time remaining in the preceding interval m. At the expiration of interval m, the process passes to block 154 and the interval counter is incremented by one unit (e.g. an additional week). The process then advances to block 156 and the anonymized identifiers of a group x of devices 24 are thereafter updated via a new hash code. As such, until the identifiers assigned to devices 24 of this group are refreshed yet again, location estimates associated with these devices will be identified by anonymized identifiers which utilize the new hash code in subsequent intervals.

At decision block 158, the device group counter increments by one (block 160) until all t groups of devices 24 have completed an anonymized identifier refresh event. At that point, the process returns to block 146, the device group and interval counters are reset, and the rolling identifier assignment cycle reinitializes.

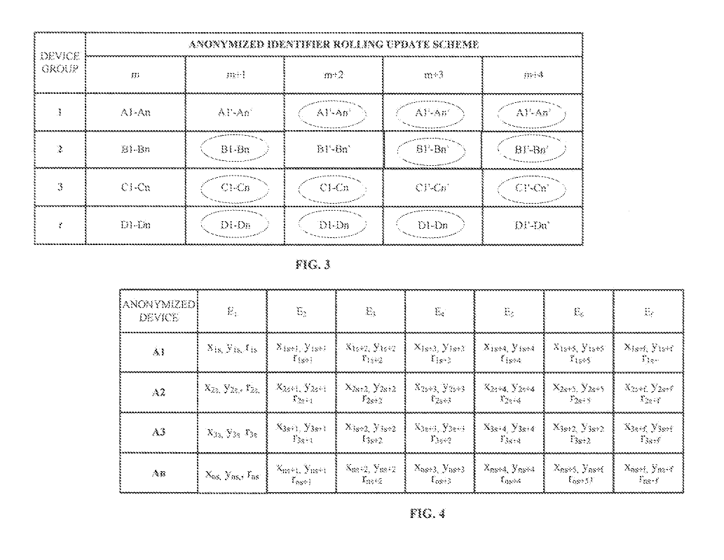

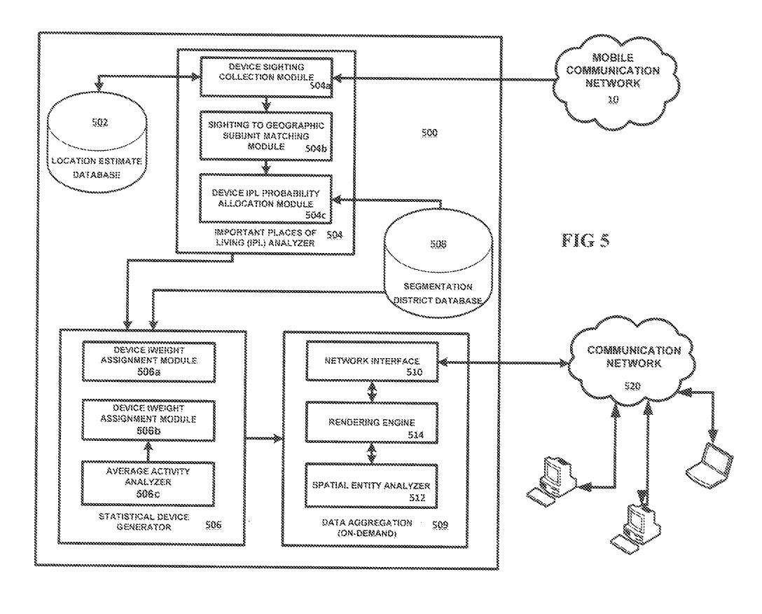

FIGS. 3 and 4 are tabular representations showing an exemplary order in which the anonymized identifiers are updated for four groups of devices 24, and an illustrative association between a plurality of location estimates E₁ through E_{f} and exemplary mobile devices A1-An. The radial measurements depicted in FIG. 4 may vary from measurement to measurement or, if the measurements are all obtained from devices in relatively close proximity to one another (and therefore, covered by the same infrastructure of networked system 10), they may be substantially equal. By way of illustrative example, the radial measurement stored in association with a corresponding set of latitude and longitude coordinates may be on the order of 100 to several thousand meters.

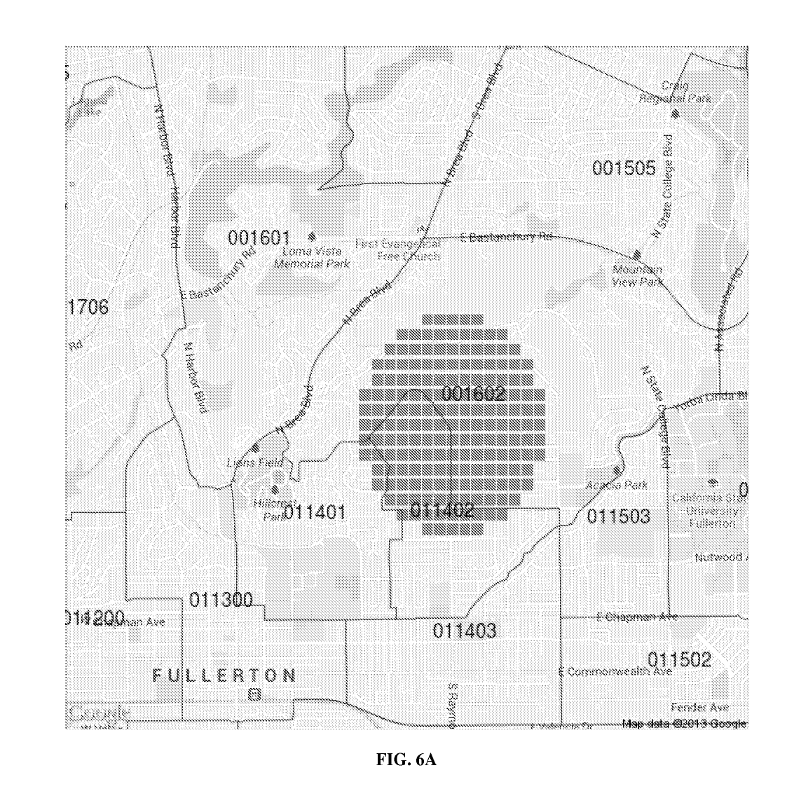

Turning now to FIG. 5, there is shown a block schematic representation of a defined area analyzer and estimate reporting system indicated generally at reference numeral 500 and configured in accordance with an illustrative embodiment of the disclosure. Illustrative system 500 includes a database 520 for receiving and storing location estimates from mobile device location server 20 (FIG. 1) of exemplary mobile communication network 10. The location estimates are supplied to an important places of living (IPL) analyzer 504 which is operative, in a manner to be described shortly, to analyze respective groups of location estimates applicable to each corresponding device and falling within a time window when the user of the device is deemed most likely to be home (e.g., “nighttime” which may be understood to commence sometime after 7 PM and to end sometime before 7 AM). The estimates are processed by a device sighting collection module indicated generally at 504a, and stored in location estimate database 502.

For purposes of efficiency, the location estimates for devices disposed within a region of interest are transmitted to and received by collection module 504a in batches at regular intervals (e.g., on an hourly, daily, or weekly basis), but they may be organized in any desired manner as, for example, by census district, political subdivision (e.g., by county), or the like.

From respective groups of location estimates falling in the aforementioned “nighttime” time window, analyzer 504 constructs a home zone location profile for each corresponding mobile device. To this end, and as will soon be described in greater detail, each location estimate that corresponds to the sighting of a first device as A1 (FIG. 1) is mapped by subunit matching module 504b to a plurality of geographic subunits which, in accordance with an illustrative embodiment, are circumscribed by the zone of confidence defined by the x and y coordinates and certainty radius. Because each geographic subunit lies within precisely one segmentation district, it is possible to tabulate the number of times each geographic subunit is encompassed by a location estimate. From such tabulation, and following the application of optional filtering criteria, device IPL_{H} probability allocation module 504c identifies those subunits which collectively comprise a home zone location. The home zone location identified for a given device may encompass one or more segmentation districts, with allocation module 504c assigning to each such encompassed district a probability value p reflecting the relative likelihood that each home district candidate is the true “home” for the owner of the applicable device. As such, the sum of the probabilities for all home candidates comprising the “home zone” will always equal unity.

It will, of course, be readily appreciated by the artisan of ordinary skill that other important places of living may be readily identified by analyzing groups of location estimates falling within a different time window than that used in the identification of the segmentation district(s) comprising a home zone location such, for example, as a window selected to encompass the times when a user would be at work or school.

In any event, and with continued reference to FIG. 5, it will be seen that a statistical device generator indicated generally at reference numeral 506 is operatively associated with IPL analyzer 504 and a segmentation district database indicated generally at reference numeral 508. A segmentation district may be any uniquely defined geographic area for which reliable segmentation data has been previously compiled and made available for market research analysis. By way illustrative example, a segmentation district may be a single census tract or one or more census blocks making up such a tract.

A census block is the smallest geographic unit used by the United States Census Bureau for tabulation of 100-percent data (data collected from all houses, rather than a sample of houses). Several blocks make up block groups, which again make up census tracts. There are on average about 39 blocks per block group, but there are variations. Blocks typically have a four-digit number, where the first number indicates which block group the block is in. For example, census block 3019 would be in block group 3. The number of blocks in the United States, including Puerto Rico, is about 8,200,000. Blocks are typically bounded by streets, roads or creeks. In cities, a census block may correspond to a city block, but in rural areas where there are fewer roads; blocks may be limited by other features. The population of a census block varies greatly. There are about 2,700,000 blocks with a population of 0, while a block that is entirely occupied by an apartment complex might have several hundred inhabitants. The block group is the smallest geographical unit for which the bureau publishes sample data, i.e. data which is only collected from a fraction of all households. Census block groups are identified by a number, usually a single digit. This number determines the first digit of all the census blocks contained within a block group. For instance, census block 2 includes any block numbered 2000 to 2999.

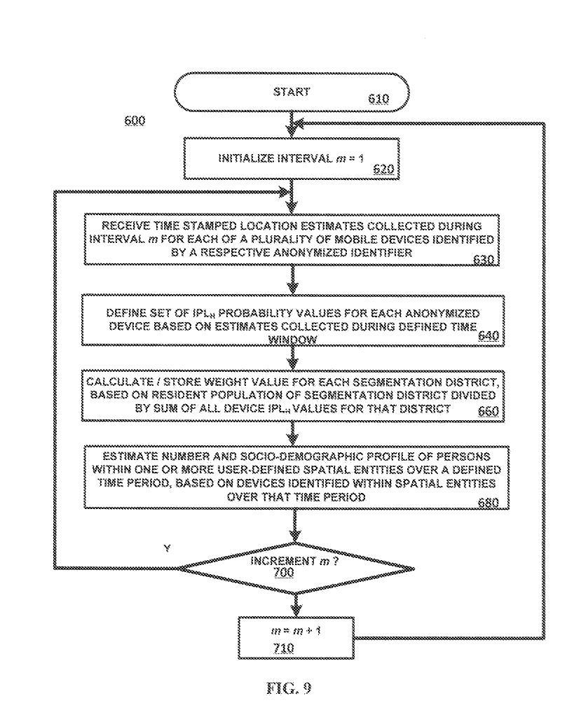

In a manner which will be explained shortly in connection with FIGS. 9-11, statistical device generator 508 assigns a tract weight which takes into account the population of each of the one or more segmentation districts identified as being relevant to each device by IPL analyzer 504—for use by statistical device generator 506 in deriving the “iWeight” of each device. Statistical device generator 506 also takes into account time varying fluctuations in the number of active devices within a region (more activity during daytime, less during night time, etc), using this data to derive a “tWeight” that is applied to each device. Through the weighting processes performed by statistical device generator 506, each anonymized mobile device that has been identified as having been located in a given area of interest (city block, shopping center, neighborhood, entertainment event, etc) is tracked not as the device of a particular individual but, rather, as a “statistical device”. That is, the movements of a single device do not represent an individual in the area of interest, but rather they represent the movement of a much larger group of people. Using this analytical framework, privacy expectations of mobile communication network subscriber are maintained, while meaningful information can be identified and reported to a variety of interested parties.

To this end, on-demand data aggregation module 509 includes a network interface 510. Network interface 510 is configured to receive queries from users of terminals communicatively coupled to communication network 520 and to exchange information with such users. By way of illustration, a spatial entity of interest may be defined using a graphical user interface (GUI) (not shown) in which a polygon is stretched as an overlay on a neighborhood map. The spatial entity so specified is analyzed by spatial entity analyzer 512, the analyzer 512 being configured to process available location estimates any devices which interacted with communication network 10 (FIG. 1) while disposed within the defined spatial entity. The IPL_{H} profile of each device so identified (which specifies the representative segmentation district(s) represented by that device) may then be used, in combination with the corresponding segmentation tract weight(s), to compute the number and socio-demographic composition of a group of people represented by that device.

The number and socio-demographic characteristics of the group of people represented by each tracked “statistical device” can vary in accordance with the simplicity (or complexity) of the model applied. In a simplified approach, each device is assigned an iWeight which reflects both the segmentation districts that device represents (as represented by the constituent probabilities), the differences in population between represented segmentation districts, and the census tract weights. In a basic example wherein only a single district is represented by a given device (p=1.00), the segmentation district weighting factor (the ratio of the segmentation district's resident population to the sum of p-values for all devices at least partially mapped to that district) yields a raw number of people represented by the device. The socio-demographic composition of that raw number corresponds to that of the corresponding district.

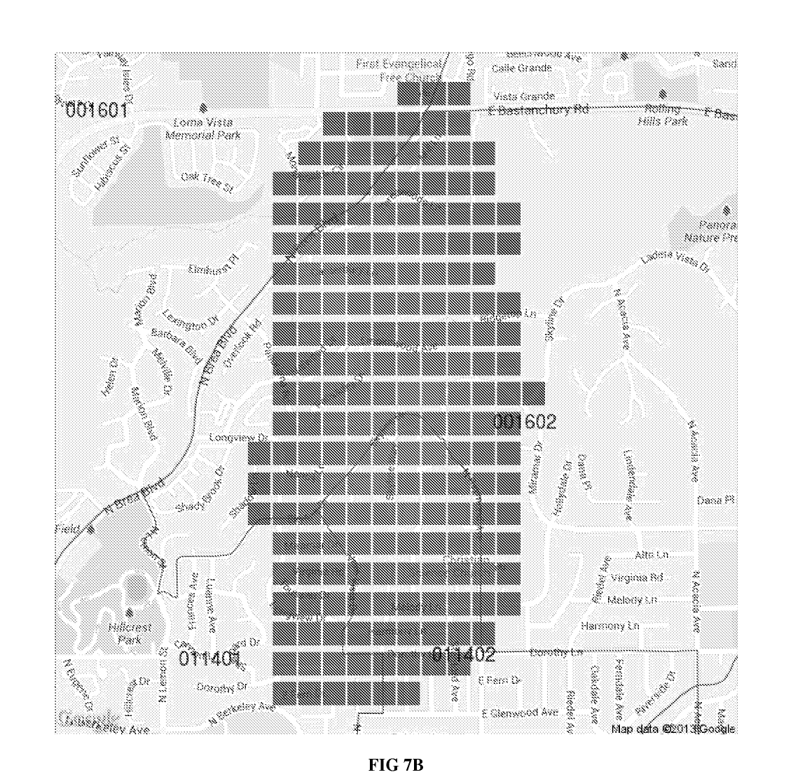

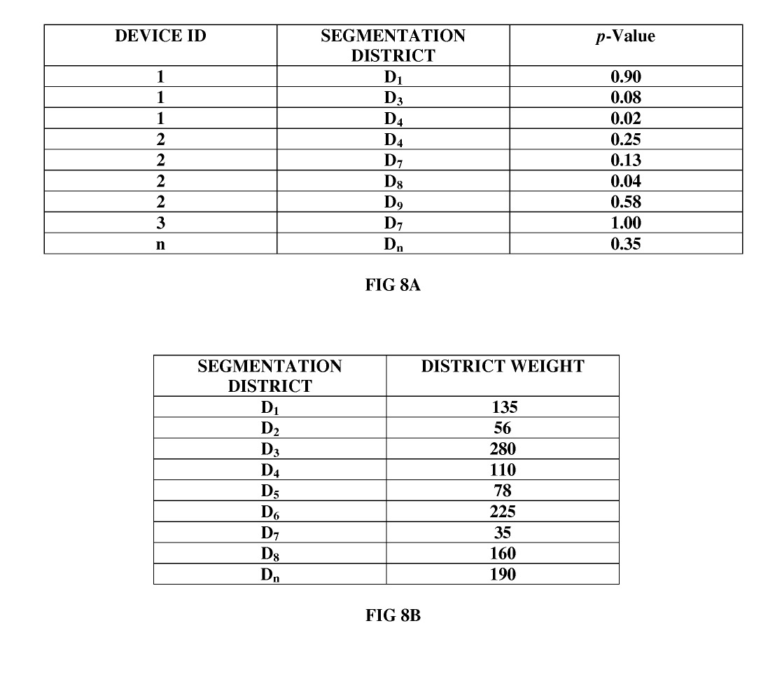

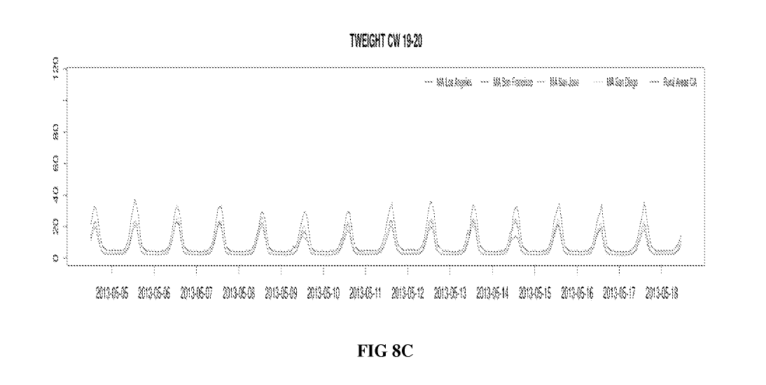

Due to time varying fluctuations in the number of active device users in a given region (as exemplified by FIG. 8C), it may be desirable to make further adjustments by applying a time varying “tWeight” factor. By way of representative example, at certain times of the day (particularly in the evening), the number of active devices is reduced. To address this, each device identified by spatial identity analyzer 512 may be weighted at particular times of day to represent more (or less) persons than at other times of day.

Rendering engine 514 utilizes the information retrieved and analyzed by spatial entity analyzer 512 to develop a graphic representation of such information as the number and socio-demographic profile of persons within the area of interest over a selectable time period. Using an appropriate user interface (not shown), users of computer terminals connected to network 520 may circumscriber areas of interest using, for example, manipulable polygons projected onto a city map encompassing those areas of interest.

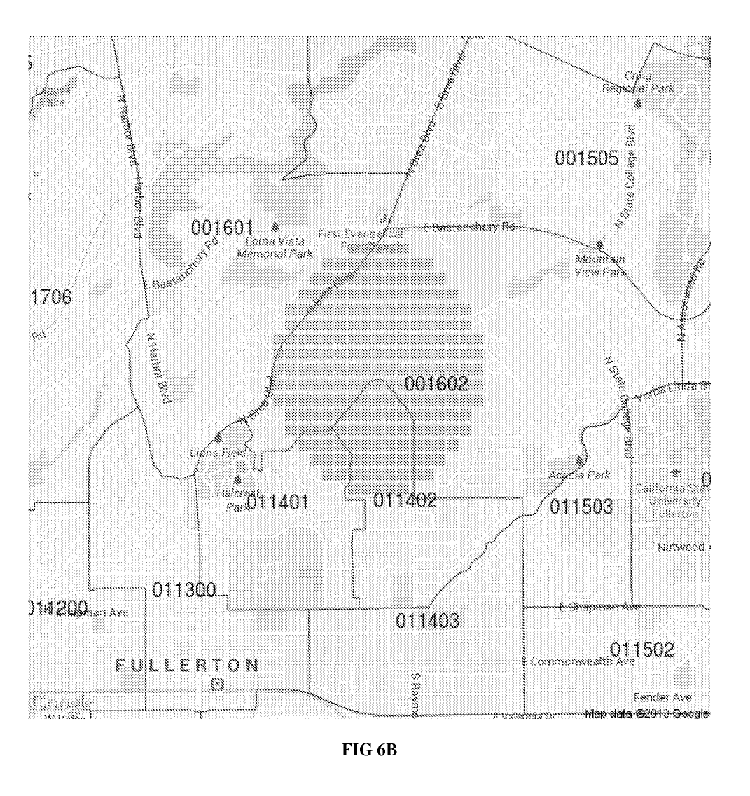

With particular reference now to both FIG. 4 and FIGS. 6A-8C, an exemplary approach to analyzing anonymized location estimates so as to identify one or more segmentation districts corresponding to a home location of each location will now be described in greater detail. FIGS. 6A-6C, for example, depicts the superposition of the location estimates tabulated in the FIG. 4 for the exemplary device A1, onto a coverage grid of adjacent geographic subunits, with each identifiable geographic subunit being situated within exactly one segmentation district. The geographic subunits may be on the order of 100 meters by 100 meters, which compares to the radius of a typical location estimate that may be on the order of from tens of meters to hundreds of meters. For purposes of the present discussion, it will be assumed that location estimates, indicated generally at E₁ through E_{f} for respective devices A1 to An of device group 1, were taken over a span of time during which the corresponding device owner would be expected to be home (e.g., night time hours which, for the sale of illustration, may commence between 7 PM and 9 PM and end somewhere between 5 AM and 7 AM), and that the analysis discussed herein applies to the identification of one or more segmentation districts corresponding to a device owner's place of residence. However, as should be readily apparent to those of ordinary skill in the art, the same analytical approach is equally applicable to the task of assigning devices to one or more user-defined areas of interest.

Within initial reference to FIG. 6A, it will be seen that the geographic subunits falling within the location estimate E1 for device A1 (FIG. 4) are dispersed among three separate segmentation units (census districts in this example) indicated generally at reference numeral 1602, 11402 and 11401, respectively. Likewise, as seen in FIG. 6B, the geographic subunits falling within the location estimate E2 for device A1 are also dispersed among segmentation units 1601, 1602, 11401 and 11402. Finally, and as seen in FIG. 6C, the geographic subunits falling within the location estimate En for device A1 are dispersed amongst the four segmentations units indicated generally at 1601, 1505, 1602 and 11402, respectively. It should be emphasized that the exemplary subunit/location estimate grid-mapping process of FIGS. 6A-6C is repeated for all available location estimates (within the “nighttime” time period associated with the IPL_{H} determination) for every device.

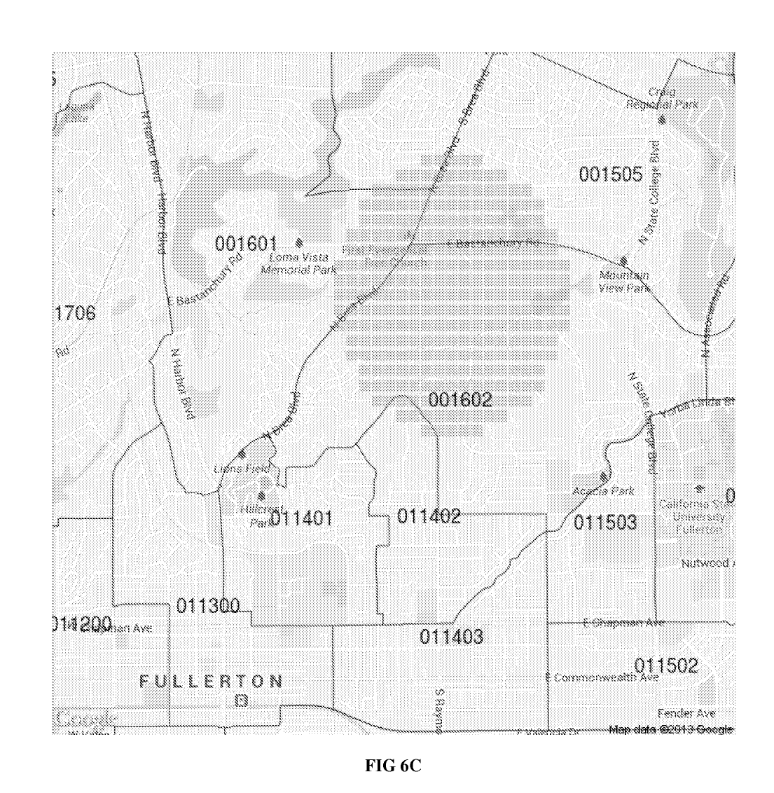

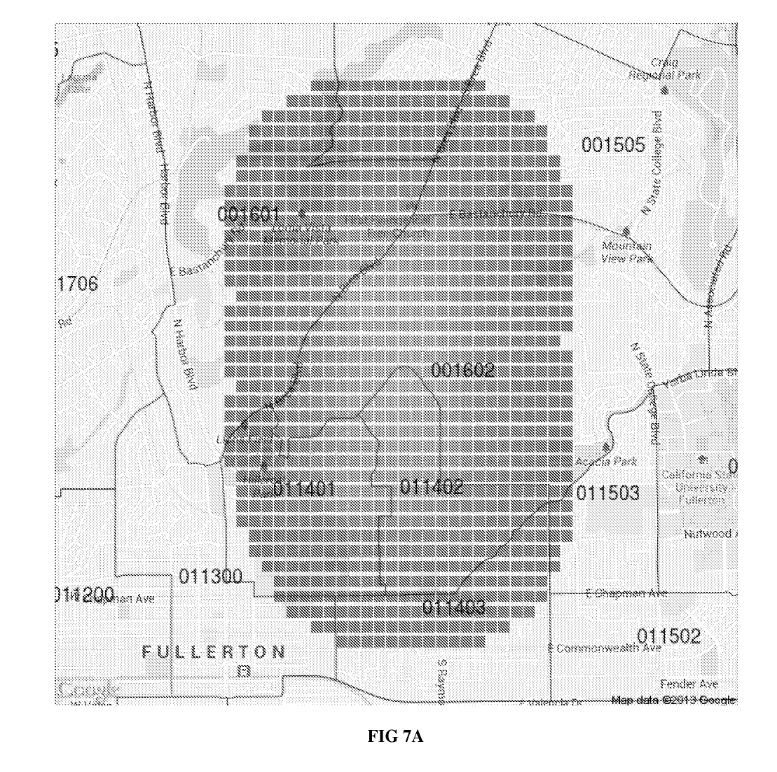

FIG. 7A depicts the collective projection of all geographic subunits associated with location estimates E1 through En for the exemplary device A1 onto the segmentation district map used throughout FIGS. 6A-6C, with color coding being employed to readily distinguish those subunits having a higher incidence of occurrence among the location estimates from those which are less common. The result is a grouping of core geographic subunits (shown in red) that collectively defines a “core” home zone surrounded by a “fringe” or ring of less frequently implicated subunits.

FIG. 7B depicts the core home zone following the completion of a filtering process. A number of filtering criteria may be employed to shrink the size of the home zone. One option is to discard any subunit which does not appear in a threshold number of location estimates or, by way of alternative example, that does not appear at least x % (e.g., 80%) as often as the most commonly appearing geographic subunit. An additional criterion might be to discard any sub units which occurs appear in an estimate less frequently than every x days or hours, where x is selected so that a separation of more than a three or four days might reflect an occasional night spent at a popular gathering place away from home.

As seen in FIG. 7B, what emerges from the estimate aggregation and filtering process is a core home zone that comprises a number of contiguous subunits and may span a number of segmentation units. An inference to be drawn from an examination of FIG. 7B is that the home zone encompasses four segmentation districts —1601, 1602, 11401, 11402. In other words, the home location of the device A1 may lie within any of these four segmentation districts. Turning now to FIG. 8A, in which the specific segmentation districts which characterized FIGS. 6A-7B have been replaced by the generalized representations D1-Dn for clarity of illustration and ease of explanation. A probability value (p-values) is assigned to each of the segmentation districts which may be the home district for device A1—on the basis of such factors as the relative distribution of subunits amongst the candidate districts and the differences in population density amongst adjacent districts. In the former regard, it will be readily understood that if 70% of the core zone subunits are associated with segmentation district D1 then, all things being equal, the probability that segmentation unit D1 is the home location should equal or even exceed 70%. In the latter regard, however, it is deemed by the inventors herein to accord a higher weighting to a smaller grouping of subunits disposed within a densely populated segmentation district than to a more numerous group of subunits dispersed within one or more sparsely populated segmentation districts. In the illustrative example of FIG. 8A, the device A1 is depicted as having a 90% probability of being within district D1, an 8% probability of being within district D3 and a 2% probability of being within district D4.

Turning now to FIG. 8B it will be appreciated that for each segmentation district, a weighting factor may be derived by summing the p-values for all devices having a p-value associated with that district. The inventors herein have recognized that this sum of probabilities (Σp) can function as an effective proxy for the true (but unknown) number of devices actually belonging to owners residing in a given segmentation district. To this end, a weight factor for each segmentation district is derived by dividing the total resident population of the segmentation district by the corresponding Σp value for that segmentation district. As will be discussed shortly, this weight factor allows each device detected in a defined area of interest to serve as a “statistical device” and to thereby represent a large group of people. The number and socio-demographic profile of the group so represented can be estimated by applying the respective weight factors—for each of the segmentation districts represented by each device—to the corresponding probability fraction allocated to the devices. With continued reference to FIG. 8b, device A3 has a p-value of unity, corresponding to its singular association with segmentation district D₇. This, if the district weight for D₇ is 35, then subject to any time of day weighting by application of a tWeight, the presence of device A3 within an areas of interest corresponds to thirty five people whose socio-demographic profile matches that of segmentation district D₇. Considering device A1, on the other hand, there are three separate segmentation districts D1, D3 and D4, having a respective probability of 0.90, 0.08 and 0.02, respectively and corresponding district weights of 135, 56, and 110, respectively.

In the illustrative example represented by FIG. 8B, an approximation of the number and socio-demographic profile of the persons represented by the presence of device A1 in the area of interest may be obtained by obtaining the iWeight for the device. The iWeight is derived by blending the respective contributions of all three potential home segmentation districts—as defined by their respective p-values for the device. Thus, for example, district D1 contributes a district weight of 135 adjusted by a p-value of 0.90 to yield an iWeight component of 122, while district D3 contributes a district weight of 280 adjusted by a p-value of 0.08 to yield an iWeight component of 11, and district D4 contributes a district weight of 110 adjusted by a p-value of 0.02 to yield an iWeight component of 2.

By summing the respective contributions of each of the three illustrative segmentation districts associated with the home zone location for device A1, an iWeight of 135 is obtained. A blended socio-democratic profile for device A1 may be obtained in an identical fashion, and it will likewise be understood that the above-described process may be readily repeated until the number and profile represented by each device identified in a defined zone of interest has been derived. It follows that by summing all of the estimates derived in this manner, an estimate of the number of people passing through a defined area of interest can be readily obtained and reported in response to user inquiries.

Turning now to FIG. 8C, there is shown a graphical representation of the tWeight as needed to account for time varying fluctuations in the number of devices active over the course of a fourteen day interval. The timestamps on the x-axis refer to Greenwich Mean Time (GMT). The peaks of the graph depict the hours of lowest activity (and therefore highest tWEIGHT value). So, for example, a device identified in a zone of interest during the evening hours might have a temporal weighting factor of 10 to 15, while a device identified in a zone of interest during the daylight hours may have a weighting factor of 2 to 3 only, the precise values being selected so as to account for the variations in the number of discrete, anonymized mobile devices available for use as statistical devices in accordance with the teachings of the present invention.

FIG. 9 is a flow chart representing exemplary machine readable instructions that may be executed, in accordance with the exemplary embodiment of the invention depicted in FIG. 5, to process and analyze anonymized location estimates and provide estimates of the number of socio-demographic profiles of persons with one or more defined areas of interest over a selectable time frame. As seen in FIG. 9, the process 600 is entered at start block 610 and proceeds to block 620 wherein an interval counter is initialized and then the process advances to block 630 wherein location estimates are received and anonymized via a one way hashing algorithm on a rolling basis. At block 640, at least one important place of living which includes a home area for each device owner is generated. The process then proceeds to block 660, at which point a statistical device weight for population and profile is obtained for each segmentation district and, at block 680, the statistically weighted devices sighted in a user-defined area of interest are accumulated for subsequent use in computing and reporting the number and profile of persons in the area over one or more defined intervals via, for example, a communication network such as the internet. At decision block 700, a decision is made as to whether the final interval m of an identifier refresh cycle has been reached. If not, the interval counter m increments by 1 (block 710) and if so, then the interval counter reinitializes at block 620.

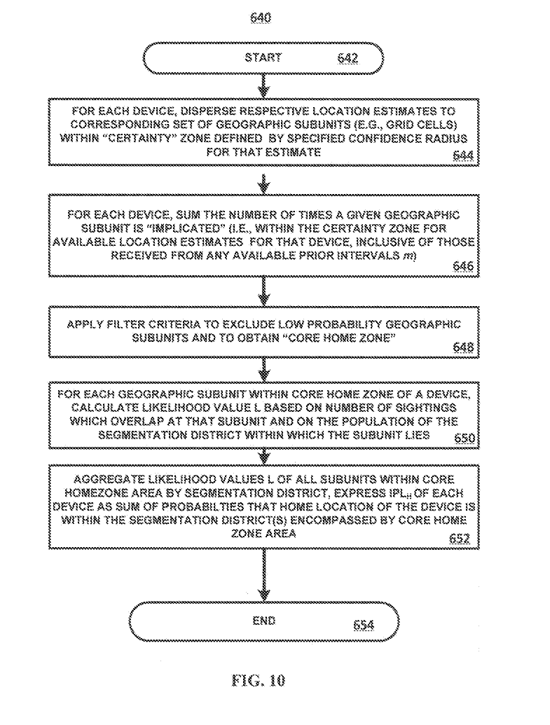

FIG. 10 is a flow chart representing exemplary machine readable instructions that may be executed, in accordance with the exemplary embodiment of the invention depicted in FIG. 5, and block 640 of the illustrative process depicted in FIG. 9, to assign each anonymized device to one or more segmentation districts. The sub-process 640 commences at start block 642 and passes to block 644, whereupon for each device, location estimates are dispersed (projected onto) a corresponding set of geographic subunits taking into account a confidence radius or other measurement provided with each set of estimate coordinates. At block 646, the area of all “implicated” geographic subunits as defined by the confidence radius of all available location estimates (including those received from any prior intervals m). Those implicated subunits exceeding a probability weighting threshold or meeting other definable filter criteria are included in the home location identification (block 648) for each device, at which point the process proceeds to block 660. At block 650, for each geographic subunit within the core home zone of a device, a respective likelihood value L—based on the number of sightings (location estimates) which overlap that subunit and based on the resident population of the segmentation district within which the subunit lies. The process then proceeds to block 652, at which point the likelihood values L are aggregated for all values L of all subunits within the core home zone location area by segmentation district, and the IPL_{H} or estimate of home zone location is expressed as a sum of probabilities that the home location of each device is within the segmentation districts encompassed (i.e., at least partially overlapped) by the core home zone area. After performing this process using all available location estimates for all devices falling within the time period set for defining the home zone location, the process terminates at block 654.

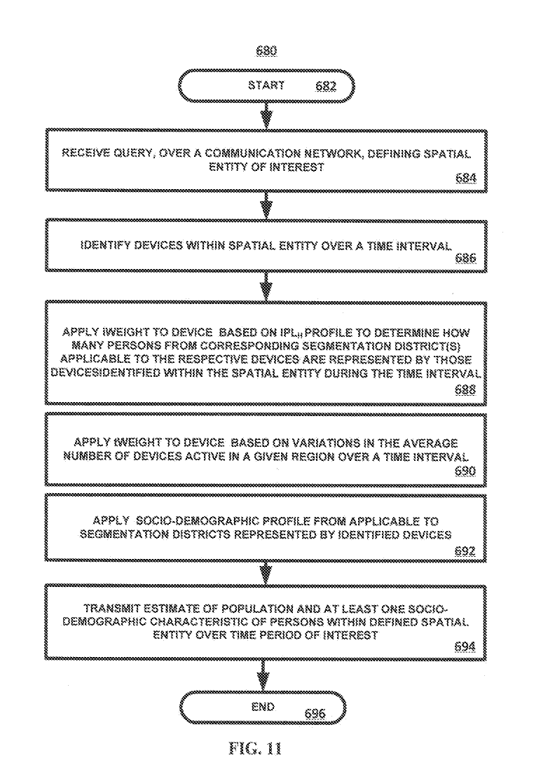

FIG. 11 is a flow chart representing exemplary machine readable instructions that may be executed, in accordance with the exemplary embodiment of the invention depicted in FIG. 5 and the illustrative sub process 680 depicted in FIG. 9, to generate, render and graphically depict estimates of the number and socio-demographic profile of persons within a defined area of interest over a selectable time frame. The process 680 begins at start block 682, whereupon a query is received over a communication network at block 684. Typically, the query specifies a spatial area of interest which may, for example, be city block containing one or more retail outlets of interest, or it may be a shopping mall or large retailer, or even an entertainment venue. In accordance with an exemplary embodiment of the invention, the query may specify a polygon with reference to a set of latitude and longitude coordinates or map. The query may further specify a user-defined area for which such information as the number and socio-demographic profile of people is requested over a selectable period of time (hour to hour, day of week, etc). At block 686, the accumulated location estimates—which as mentioned earlier include the start time, duration, latitude, longitude and certainty radius for respective anonymized mobile communication devices—are analyzed to identify any devices which were disposed within or close to the spatial area of interest defined by a prior or current user query. Because the radius and other information associated with any given location estimate for a device may not be sufficiently precise as to define with absolute certainty whether or not that device was actually inside the area of interest, the analysis includes a step of determining the maximum degree of overlap between all sightings of a given device and the spatial area of interest (“target area”) within a defined time period. If a device is determined to only be partially inside the target area, then its iWEIGHT and tWEIGHT are scaled by a “presence factor” to express the likelihood that the device was in the particular area of interest.

At block 688, a segmentation district weighting factor is retrieved for all segmentation districts applicable to a given device, and these, along with the device iWeight and tWeight (block 690), are used to derive an estimate for the total number and social demographic profile all persons disposed within the defined spatial area of interest. (block 692). The average socio demographic profiles and population estimates associated with the respectively identified devices are summed at block 692 and the results are then transmitted over the communication network for display to the user(s) (block 694). Once a spatial area of interest has been defined, the results for that area may be continuously updated as new data is made available, so that it is available for presentation to the user on demand and in real-time.

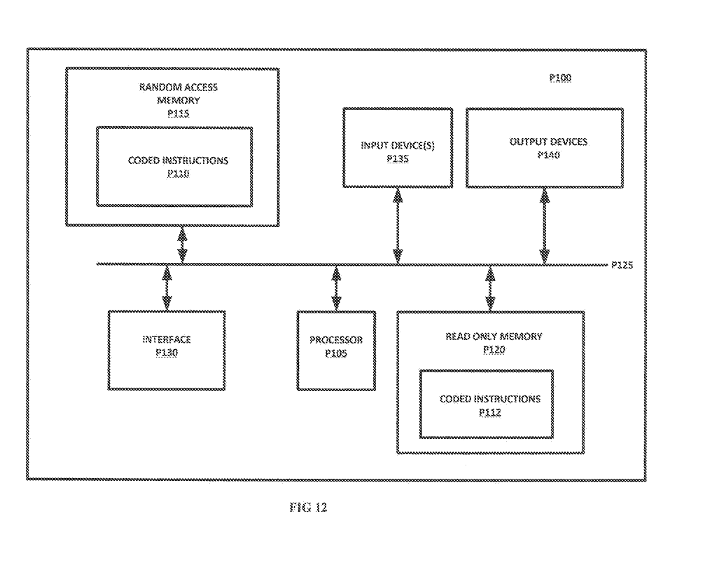

Turning finally to FIG. 12, there is shown a block diagram of an example processor system 900 that may be used and/or programmed to execute the example machine readable instructions of FIG. 2 or FIGS. 9-11 and to otherwise to implement any of the example systems, apparatus, and/or methods described herein. For example, the processor platform P100 can be implemented by one or more general-purpose processors, processor cores, microcontrollers, etc. The processor platform P100 can be, for example, a server, a personal computer, a mobile phone (e.g., a cell phone), an Internet appliance, or any other type of computing device.

The processor platform P100 of the example of FIG. 13 includes at least one general-purpose programmable processor P105. The processor P105 can be implemented by one or more Intel® microprocessors from the Pentium® family, the Itanium® family or the XScale® family. Of course, other processors from other families are also appropriate. The processor P105 executes coded instructions P110 and/or P112 present in main memory of the processor P100 (for example, within a RAM P115 and/or a ROM P120). The coded instructions may be, for example, the instructions implemented by FIGS. 9-12. The processor P105 may be any type of processing unit, such as a processor core, a processor and/or a microcontroller. The processor P105 may execute, among other things, the example process of FIGS. 9-12 to implement the example methods and apparatus described herein.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. Access to the memory P115 and the memory P120 may be controlled by a memory controller (not shown).

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130. The interface circuit P130 can be implemented by, for example, a keyboard, a mouse, a touchscreen, a track-pad, a trackball, isopoint and/or a voice recognition system. The output devices P140 can be implemented, for example, by display devices (e.g., a liquid crystal display, a cathode ray tube display (CRT), a light-emitting-diode (LED) display, a printer and/or speakers).

Although certain example methods, apparatus and articles of manufacture have been described herein, the scope of coverage of this patent is not limited thereto. Rather, this patent covers all methods, apparatus and articles of manufacture falling within the scope of the appended claims either literally or under the doctrine of equivalents.

What is claimed:

1. A method, comprising:
randomly assigning a plurality of mobile devices to one of t groups;
collecting location estimates for each of the plurality of mobile devices within each group, each location estimate defining a circumscribed area within which a device was located at a specified date and time;
anonymizing with a processor, each corresponding mobile device for which location estimates were collected; and
associating, with the processor, each collected location estimate with an anonymized mobile device.

2. The method of claim 1, wherein each location estimate is characterized by a pair of orthogonal coordinates and a linear measurement so as to collectively define a circumscribed area.

3. The method of claim 2, wherein the linear measurement is a radius having a length of between 10 m and 3000 meters.

4. The method of claim 1, wherein mobile devices are anonymized by applying a one-way hash code to an identifier applicable to a corresponding mobile device to thereby obtain a respective anonymized identifier for the corresponding mobile device.

5. The method of claim 3, further including
a step of applying a replacement hash code to a first group of mobile devices at expiration of a first time interval; and
a step of associating each location estimate applicable to a device of the first group and collected during the first interval with a corresponding replacement anonymized identifier.

6. The method of claim 4, further including
a step of applying the replacement hash code to a second group of mobile devices at expiration of a second time interval subsequent to the first interval; and
a step of associating each location estimate applicable to a device of the first group and the second group and collected during the second interval with a corresponding replacement anonymized identifier.

7. The method of claim 5, further including a step of transmitting anonymized location estimates over a communication network for remote segmentation analysis.

8. The method of claim 1, further including a step of transmitting anonymized location estimates over a communication network for remote segmentation analysis.

9. A method comprising:
collecting location estimates for each of a plurality of mobile devices, each location estimate defining a circumscribed area within which a corresponding mobile device was located at a specified date and time;
identifying, with a processor, an important place of living for a first of the plurality of mobile devices by correlating location estimates applicable to the first mobile device to a plurality of segmentation districts, each segmentation district having associated therewith at least one of a count of people residing therein and a socio-demographic profile of people residing therein; and
identifying, with the processor, an important place of living for a second of the plurality of mobile devices by correlating location estimates applicable to the second mobile device to at least one segmentation district.

10. The method of claim 9, wherein each location estimate includes a pair of orthogonal coordinates and a linear measurement so as to collectively define a circumscribed area.

11. The method of claim 10, wherein the linear measurement is a radius having a length of between tens and hundreds of meters.

12. The method of claim 9,
wherein a first group of location estimates were made during a first defined time window when each owner of a corresponding mobile device is expected to be at home; and
wherein the step of identifying an important place of living for a first mobile device includes
selecting those location estimates applicable to the first mobile device and made during the first defined time window, and
projecting, onto a uniform grid of geographic subunits, respective circumscribed areas associated with each selected location estimate.

13. The method of claim 12, wherein a length and width of each geographic subunit are substantially equal such that each geographic subunit has a square configuration.

14. The method of claim 12, further including a step of aggregating, with the processor, those adjacent geographic subunits having a probability of containing a home of an owner of the first mobile device above a threshold, to define a home location for the first device.

15. The method of claim 14, further including a step of assigning, with the processor, a first segmentation district as having a first probability of containing the home location of the first mobile device on the basis of at least some geographic subunits being disposed within the first segmentation district.

16. The method of claim 15, further including a step of assigning, with the processor, a second segmentation district as having a second probability of containing the home location of the first mobile device on the basis of at least some geographic subunits being disposed within the second segmentation district.

17. The method of claim 16, further including a step of assigning, with the processor, a statistical weight to the first mobile device in accordance with the relative distribution of people living in each of the segmentation district and the second segmentation district, wherein the device represents a first statistically weighted number of people from the first segmentation district and a second statistically weighted number of people from the second segmentation district.

18. The method of claim 17, further including a step of assigning, with the processor, an overall socio-demographic profile to all persons represented by the first mobile device.

19. The method of claim 18, further including a step of assigning, with the processor, one or more segmentation districts corresponding to a home location of other mobile devices in accordance with the first group of location estimates.

20. The method of claim 19, further including a step of assigning, with the processor, a statistical weight to the other mobile device in accordance with the relative distribution of people living in each of the one or more segmentation districts applicable to corresponding mobile devices, wherein each device represents a statistically weighted number of people from at least one segmentation district.

21. The method of claim 20, further including a step of assigning, with the processor, an overall socio-demographic profile to all persons represented by each of the other mobile devices.

22. The method of claim 21, further including a step of receiving a request for information relating to a number of people estimated to be present in a defined area of interest over a selectable period of time.

23. The method of claim 22, further including a step of deriving an estimate of a number of people within the defined area of interest by identifying, with the processor, a plurality of mobile devices disposed within the defined area of interest during the selectable period of time in accordance with a second group of location estimates made during a time window encompassing the selectable period of time.

24. The method of claim 23, further including a step of summing a number of persons statistically represented by each of the plurality of mobile devices identified within the defined area of interest.

25. The method of claim 24, further including a step of summing average socio-demographic profiles of all persons represented by each of the plurality of mobile devices within the defined area of interest to thereby provide an estimate of both a number and a socio demographic profile of persons within the defined area of interest over time.

26. The method of claim 25, further including a step of transmitting, over a communication network, an estimate of at least one of the number and socio-demographic profile of persons within the defined area of interest.

27. The method of claim 26, further including a step of graphically presenting transmitted estimates for a defined area of interest together with a map circumscribing the defined area of interest.
